(19) United States
(12) Patent Application Publication
(10) Pub. No.: US 2012/0247601 A1
(43) Pub. Date: Oct. 4, 2012

(54) Flexible Hose During Pressurization

(76) Inventor: Glenn Allen Ayers, Pompano Beach, FL (US)

(21) Appl. No.: 13/329,014

(22) Filed: Dec. 16, 2011

Related U.S. Application Data
(60) Provisional application No. 61/465,953, filed on Mar. 28, 2011.

(51) Int. Cl. F16L 11/20

(52) U.S. Cl. 138/124

(57) ABSTRACT

The present disclosure pertains to a hose having an internal layer made of material that limits radial expansion and retains flexibility, an external layer, a gap between the exterior surface of the internal layer and the interior surface of the external layer, a valve member, and a device member, where the hose retains flexibility upon the application of a radial force to the internal layer.

### CROSS-REFERENCE TO RELATED APPLICATION

This application claims the benefit of priority to U.S. Provisional Application No. 61/465,953, filed on Mar. 28, 2011, which is incorporated herein by reference in its entirety.

### BACKGROUND

Conventional flexible hoses with a flexible external layer and an internal layer typically become stiff and difficult to bend when pressurized or a radial force is exerted on the internal layer. These types of hoses are used primarily with hand held devices for dispensing pressurized liquids and air. When these flexible hoses are pressurized by liquids or air, the internal layer expands and exerts a force against the interior surface of the external layer. This force exerted on the interior surface of the external layer makes the external layer rigid and causes difficultly when the user attempts to bend the hose and maneuver the hand held device.

### SUMMARY OF THE INVENTION

The present disclosure pertains to a hose having an internal layer made of material that limits radial expansion and retains flexibility, and an external layer, where the hose retains flexibility upon the application of a radial force to the internal layer. In one aspect of the disclosure, the hose has a gap between the exterior surface of the internal layer and the interior surface of the external layer. In one aspect of the disclosure, the internal layer is made of a thermoplastic. In one aspect of the disclosure, the external layer is woven. In one aspect of the disclosure, the external layer is braided. In one aspect of the disclosure, the external layer is interlocking. In one aspect of the disclosure, the hose has a valve member. In one aspect of the disclosure, the hose has a device member.

With those and other objects, advantages and features on the invention that may become hereinafter apparent, the nature of the invention may be more clearly understood by reference to the following detailed description of the invention, the appended claims, and the drawings attached hereto.

### BRIEF DESCRIPTION OF THE DRAWINGS

The accompanying drawings, which are incorporated herein and form part of the specification, illustrate various embodiments of the present invention and together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a perspective view of a portion of a hose according to an exemplary embodiment with layers partially cut away for purposes of illustration.

FIG. 2 is a cross section view of a hose according to an exemplary embodiment.

FIG. 3 is a side view of a hose according to an exemplary embodiment.

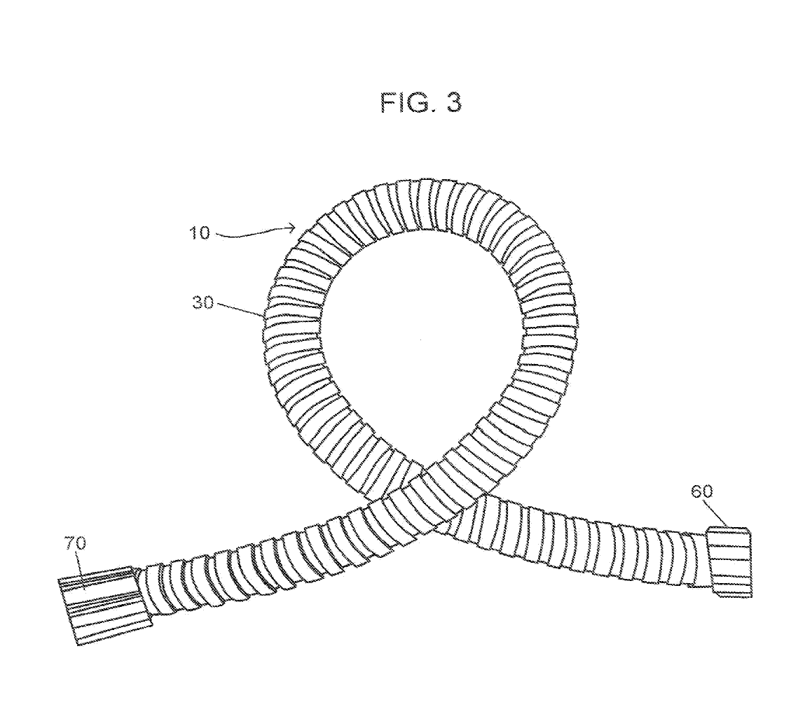

### DETAILED DESCRIPTION

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense, and the scope of the present invention is defined by the appended claims.

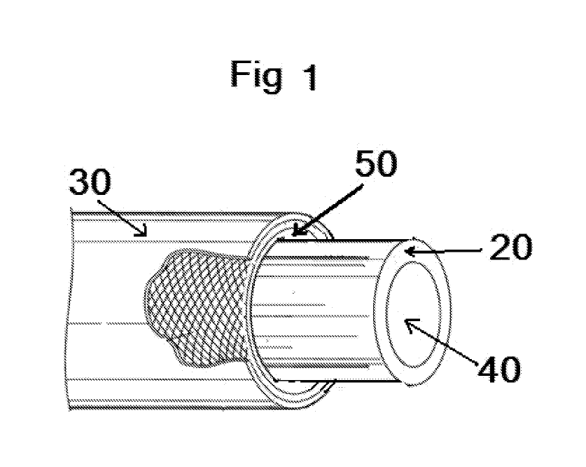

The present disclosure pertains to a flexible hose 10 that retains flexibility when pressurized. The hose 10 can be used for low, medium, or high radial force applications. The hose 10 can be pressurized by the flow of fluid or air through the hose 10. By way of example, without limitation, in this disclosure fluid will be used to describe the material passing through the hose 10. As shown in FIG. 1, the hose 10 has an internal layer 20 providing for a tubular core 40 and an external layer 30. The tubular core 40 allows for the travel of fluid through the hose 10.

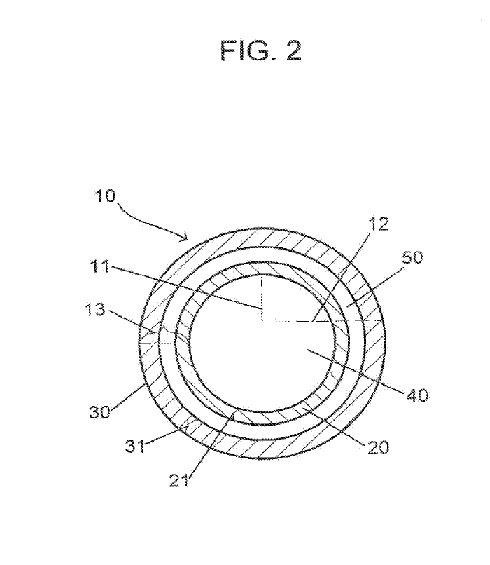

The internal layer 20 prevents or decreases radial or volumetric expansion of the internal layer 20 when the internal layer 20 is subject to radial forces or pressure caused by the fluid while retaining the flexibility of the hose 10, i.e. allowing for a small radial bend. The hose 10 extends axially to an indefinite length along a central longitudinal axis and has a select inner radius 11 and outer radius 12, as shown in FIG. 2. The inner radius 11 and outer radius 12 dimensions may vary depending upon the particular application involved. The radial bend is dependent on the outer radius 12 of the hose 10. Generally the dimensions can be between about 1/16 to ¾ inch (2 to 19 mm) for inner radius 11, and about ¼ to 1 inch (6 to 25.4 mm) for outer radius 12, with an overall wall thickness 13 of between about 1/32 to ⅜ inch (1 to 10 mm).

For example, without limitation, where the outer radius 12 of the hose 10 is 5/16 inches (8 mm) the radial bend is 1.25 inches (31 mm). The internal layer 20 can be made of any material that prevents or decreases radial expansion of the internal layer while retaining the flexibility of the hose 10. The internal layer 20 can be made of thermoplastic material, for example, without limitation, polyvinyl chloride, polyamide, polyethylene, polyurethane, fluorinated ethylene propylene, polyvinylidene fluoride, polypropylene, or the like, or synthetic rubber material, for example, without limitation, such as nitrile, neoprene, polybutadiene, butyl, polyisoprene, copolymer, or the like.

The external layer 30 covers the internal layer 20 thereby allowing flexibility to the hose 10 and protecting the internal layer 20 from damage. The external layer 30 can be any material that protects the internal layer 20 from damage and allows flexibility to the hose 10, for example, without limitation, interlocking metal, woven fiber, braided metal, or the like.

The prevention or decreased radial expansion of the internal layer 20 prevents the internal layer 20 from expanding and exerting pressure on the external layer 30, thereby preventing the hose 10 from becoming rigid due to the pressure exerted on the external layer 30 and allowing the hose 10 to retain flexibility.

In one embodiment, the hose 10 has a gap 50 between the exterior surface of the internal layer 20 and the interior surface of the external layer 30. The gap 50 allows for the maximum expansion of the internal layer 20 thereby not impeding the maximum flexibility of the external layer 30. In one embodiment, the gap 50 allows the internal layer 20 to slide in relation to the external layer 30 when the hose 10 is bent, thereby allowing for the hose 10 to retain flexibility when pressurized. Where the internal layer wall thickness 21 is between about 0.039-0.50 inches (1-12.7 mm) and the external layer wall thickness 31 is between about 0.039-0.50 inches (1-12.7 mm), the gap 50 can be between about 1/32 to ⅛ inches (1 to 3 mm). In one embodiment, the interior surface of the external layer 30 is mated against the exterior surface of the internal layer 20.

The reduction or prevention of the radial expansion of the hose 10 when subject to radial forces prevents the internal layer 20 from exerting radial pressure on the interior surface of the external layer, thereby allowing the hose 10 to retain fully flexibility.

In one embodiment, the hose 10 can have a valve member 60 that allows one end of the hose 10 to engage a valve for dispensing fluid through the valve member 60 and into the hose 10. In one embodiment, the hose 10 can have a device member 70 that allows one end of the hose 10 to engage a device. The device can be any member that allows for dispensing fluid from the hose 10 through the device, for example, without limitation, a hand held sprayer, nozzle, air tool device, hand held bidet, cloth diaper sprayer, sink sprayer, paint sprayer, pressure sprayer, air tool, or the like.

The following is a method of manufacturing the hose 10. The internal layer 20 in an uncured state can be extruded over a solid steel mandrel or flexible polymeric mandrel. The internal layer 20 may be cross-head extruded over a mandrel for support, or otherwise supported in later forming operations using air pressure and/or reduced processing temperatures. Once this unvulcanized internally layer 20 has been structured (manufactured), it can be vulcanized to completion in an autoclave on a mandrel designed appropriately for the desired curvature geometry. The internal layer 20 can then be passed through a machine, e.g. braiding machine, where the external layer 30 is formed onto the exterior surface of the internal layer 20.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

Modifications and variations of the present invention are possible in light of the above teachings. It is therefore to be understood that the invention may be practiced otherwise than as specifically described herein.

What is claimed is:

1. A hose comprising:
an internal layer made of material that limits radial expansion and retains flexibility, and
an external layer,
wherein the hose retains flexibility upon the application of a radial force to the internal layer.

2. The hose of claim 1 further comprising a gap between the exterior surface of the internal layer and the interior surface of the external layer.

3. The hose of claim 1 wherein the internal layer is made of a thermoplastic.

4. The hose of claim 1 wherein the external layer is woven.

5. The hose of claim 1 wherein the external layer is braided.

6. The hose of claim 1 wherein the external layer is interlocking.

7. The hose of claim 1 further comprising a valve member.

8. The hose of claim 1 further comprising a device member.
